(19) United States
(12) Patent Application Publication
(10) Pub. No.: US 2001/0034670 A1
(43) Pub. Date: Oct. 25, 2001

(54) Direct point of presence distribution system and method

(76) Inventor: Jeffery D. Blair, El Dorado Hills, CA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/789,678

(22) Filed: Feb. 21, 2001

Related U.S. Application Data
(60) Provisional application No. 60/188,369, filed on Mar. 10, 2000.

(51) Int. Cl. G06F 17/60

(52) U.S. Cl. 705/27

(57) ABSTRACT

The invention discloses a method that encourages supporting local retailers (20) while offering customers (14) the convenience of purchasing goods directly from the supplier (18). One embodiment has the customer (14) purchase goods directly from the supplier (18) though a facilitator (16). The facilitator (16) collects a first set of funds and purchasing information from the customer (14). Next, the facilitator (16) transmits a second set of funds to the supplier (18) and the purchasing information to both the supplier (18) and the local retailer (20). Finally, the supplier (18) transmits a third set of funds to the local retailer (20) and the goods to the customer (14). In an alternative embodiment, the first set of funds and purchasing information are sent directly to the supplier (18). The supplier (18) forwards the third set of funds and the purchasing information to the local retailer (20). Goods can be shipped directly from the supplier (18) to the customer (14). All goods are returned for a refund to the local retailer (20).

### RELATED APPLICATION

This application claims priority to and the benefits of co-pending provisional application 60/188,369 filed Mar. 10, 2000.

### BACKGROUND OF THE INVENTION

1. Field of the Invention

The subject invention is a method of doing business that encourages purchasing goods directly from the manufacturer over the internet.

2. Description of the Prior Art

Several different methods exist for distributing goods to a customer. A first example, shown in FIG. 1, is the M_D_R_C model. This model involves a manufacturer (M) selling goods to a wholesaler or distributor (D)) who resells the goods to local retailers (R) who resell the goods to customers (C). The M_D_R_C model exists primarily for two reasons. The first reason is that it is not economically feasible for the manufacturer to attempt this distribution as wholly owned. This would require the manufacturer to maintain hundreds or thousands of local retailers. The second reason for the M_D_R_C model's existence is that prior attempts at direct distribution utilizing the M_C model shown in FIG. 2 have failed. The second distribution example, the M_C model, has the manufacturer (M) selling goods directly to the customers (C). The M_C model provides manufacturers and customers with the convenience of purchasing goods without the interference of the local retailer. Usually the purchase can be made in the convenience of the customer's own home either over the phone or through the internet. This model, however, also involves excessive marketing costs, limited market exposure and poor customer responsiveness. Few companies have been successful with the M_C model.

With the increased popularity of the internet and the world wide web, companies who are currently using the M_D_R_C model are evaluating adding the M_C model. Most of these companies desire to utilize both distribution models in order to gain market share and increase sales. Unfortunately, supporting both distribution models, M_D_R_C and M_C, simultaneously creates distinct problems for the manufacturer. First, when the manufacturer uses the M_C model they are competing with their own local retailers for the same customers. Eventually this will erode the use of the M_D_R_C model. Secondly, some customers prefer the benefits of personalized sales and services by utilizing the local retailers with the M_D_R_C model of distribution. Erosion of the M_D_R_C model may lose the business of these customers altogether.

Therefore, there remains an opportunity to offer a distribution model that provides the convenience of the M_C model and the personal service of utilizing a local retailer with the M_D_R_C model.

### SUMMARY OF THE INVENTION AND ADVANTAGES

The subject invention provides a method of purchasing and selling goods electronically. The method comprises the steps of viewing an internet website by a customer, purchasing goods electronically from the internet website and determining a local retailer having jurisdiction over the purchase. Next, the method includes transmitting a first set of funds for payment of the goods. Finally, the last step of the method includes transmitting a third set of funds to the local retailer in response to the purchase.

Accordingly, the subject invention strikes a balance between the M_C and M_D_R_C distribution models. At the same time a supplier experiences the convenience of selling to its customers directly, the customer has access to personalized service from the local retailer for his purchase. By transmitting the third set of funds to the local retailers, the erosion of the M_D_R_C model by use of the M_C model is eliminated because both the supplier and local retailer are experiencing a profit from every purchase. Accordingly, the two distribution models are no longer competing for the same customers. All purchases produce benefits for both the supplier and the local retailer. Therefore, the two distribution models can exist simultaneously while the customer receives the benefits of both convenience and service.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic drawing of the M_D_R_C product distribution model;

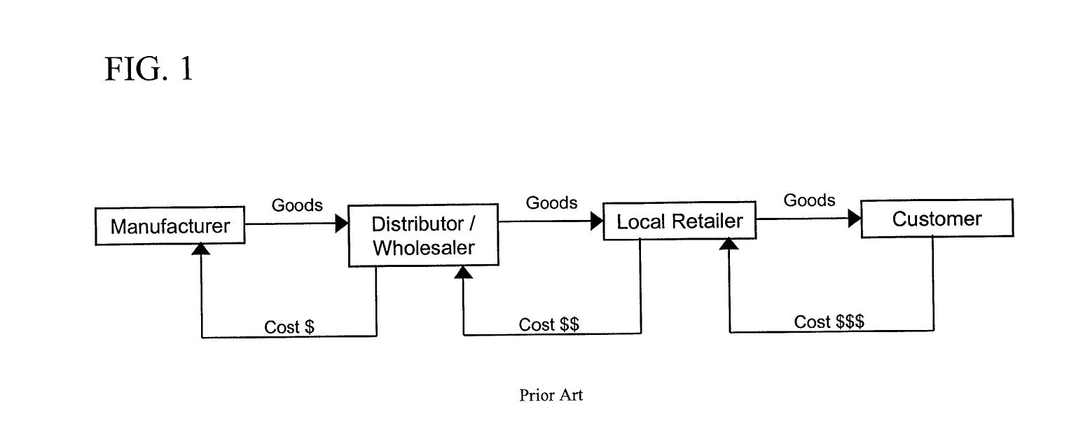

FIG. 2 is a schematic drawing of the M_C product distribution model;

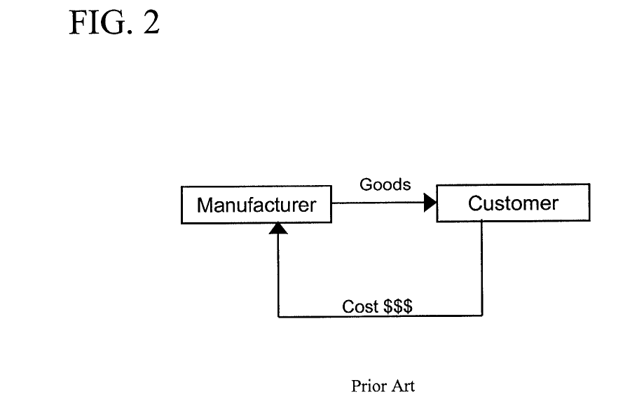

FIG. 3 is a schematic drawing of the subject invention product distribution model of the first embodiment;

FIG. 4 is a schematic drawing of the subject invention product distribution model of an alternative of the first embodiment;

FIG. 5 is a schematic drawing of the subject invention product distribution model of the second embodiment;

FIG. 6 is a schematic drawing of the distribution and return of the purchased products of the subject invention.

### DETAILED DESCRIPTION OF THE PREFERRED EMBODIMENT

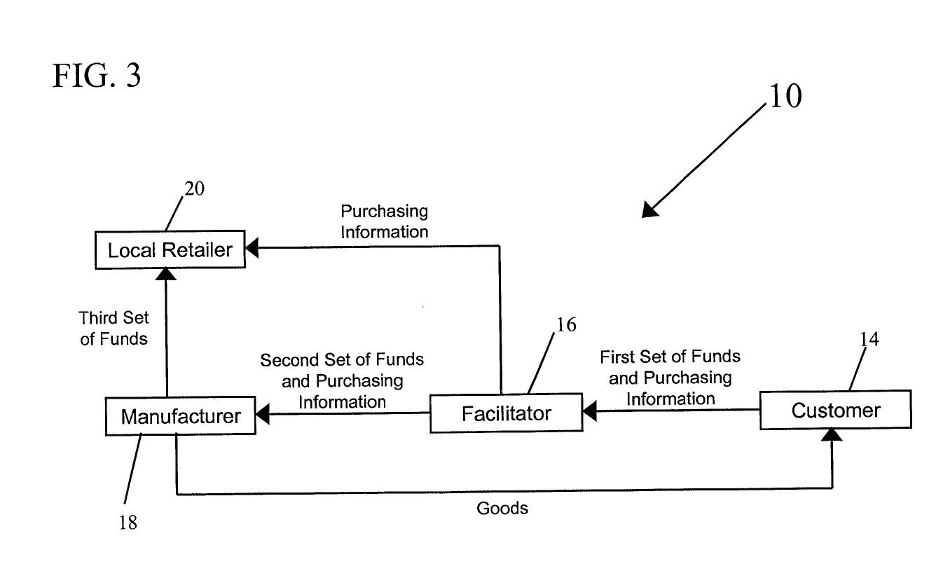

Referring to the Figures, wherein like numerals indicate like or corresponding parts throughout the several views, the subject invention includes a method of purchasing and selling goods electronically. The subject invention helps to encourage e-commerce while still supporting local retailers 20. The diagrams in FIGS. 3, 4 and 5 outline the flow of goods, funds and information in two embodiments 10 and 12 of the subject invention. Both methods 10 and 12 begin with a customer 14 viewing an internet website. The internet website sells goods to its customers 14 electronically. The customer 14 selects the desired goods and purchases them from the internet website.

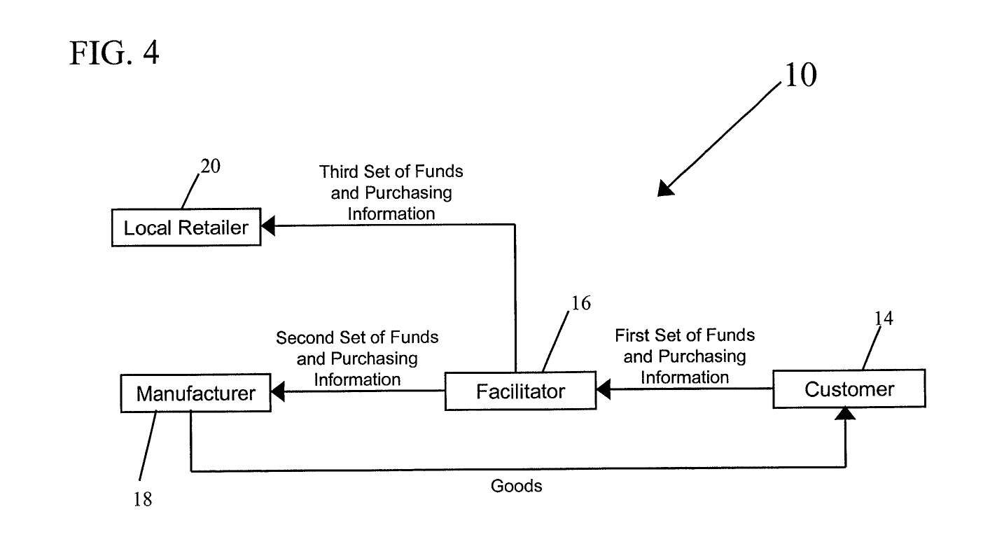

The first method 10 of the subject invention, outlined in FIGS. 3 and 4, utilizes a facilitator 16. A facilitator 16 represents a computer network capable of processing and storing various data. Initially, a supplier 18 registers with the facilitator 16 to create an account between the facilitator 16 and the supplier 18. A supplier 18 is defined as anyone selling the desired goods. The supplier 18 includes manufacturers, distributors, wholesalers, or any other type of entity that produces or distributes goods. A local retailer 20 that sells the supplier's 18 goods also registers with the facilitator 16 thereby creating an account between the facilitator 16 and the local retailer 20. To establish an account, basic transaction data is required. Specifically, the facilitator 16 must know the location of the local retailer 20 to properly define a jurisdiction for each local retailer 20 registered with the facilitator 16. The facilitator 16 must also acquire transaction data from the supplier 18 including product prices, shipping costs, and bank account information.

When the customer 14 is viewing and purchasing goods from the internet website, the customer 14 is linked to the facilitator 16. The facilitator 16 manages the internet website and coordinates the purchases of the customer 14. Upon registering with the facilitator 16, the supplier 18 receives a software program that is used to create the link between the internet website and the facilitator 16. When the internet website has already been created by the supplier 18 or one of the local retailers 20, the facilitator's 16 software program would link this previously developed internet website to the facilitator 16. If the internet website was not already developed, the facilitator 16, along with the software program, would assist the supplier 18 in the development of the necessary internet website.

When the customer 14 purchases goods from the internet website, the supplies purchasing information to the facilitator 16. The purchasing information includes data such as the customer's 14 name, address, telephone number, and credit card or bank account number. This purchasing information is stored by the facilitator 16 in a database for future reference or marketing opportunities. After the facilitator 16 collects the required purchasing information, the customer 14 must select a local retailer 20. This is accomplished by the facilitator 16 matching features of the purchasing information to the transaction data supplied by local retailers 20 carrying the supplier's 18 goods. Specifically, one method of matching the features includes the facilitator 16 matching the postal code supplied by the customer 14 to postal codes supplied by registered local retailers 20. A list is then generated of matching local retailers 20 for presentation to the customer 14. The customer 14 then selects one local retailer 20 from the generated list of matching local retailers 20. This selected local retailer 20 is notified by the facilitator 16 of the customer's 14 purchase. The notification or alert to the selected local retailer 20 includes the purchasing information and an assigned purchasing number or tracking number. The purchasing number would be used later by the customer 14, local retailer 20 or supplier 18 to reference the purchasing information associated with a specific purchase in the facilitator's 16 database. The notification or alert is sent to the selected local retailer 20 via traditional mail, fax or electronic mail.

The purchasing information supplied by the customer 14 includes a form of payment such as a credit card number or bank account number that is described in FIGS. 3 and 4 as the first set of funds. The facilitator 16 initiates the transfer of the first set of funds from the customer 14. The first set of funds is transferred from the credit card account or bank account of the customer 14 to the facilitator's 16 bank account. The facilitator 16 then subtracts a processing fee from the first set of funds. The processing fee is previously established between the facilitator 16 and supplier 18. Next, the facilitator 16 transmits a second set of funds and the purchasing information supplied by the customer 14, including the assigned purchasing number, to the supplier 18. The second set of funds is the first set of funds reduced by the facilitator's 16 processing fee. Again, the transfer of the second set of funds occurs electronically. The second set of funds is transferred from the facilitator's 16 bank account to the supplier's 18 bank account. The supplier's 18 bank account information was provided earlier by the supplier 18 to the facilitator 16 in the transaction data required for registering with the facilitator 16. The supplier 18 receives the second set of funds and processes the purchasing information. The supplier 18 then ships the purchased goods to the customer 14. The customer's 14 desired receiving location is specified in the purchasing information. The preferred embodiment shows the purchased goods being shipped directly from the supplier 18 to the customer 14. However, the purchased goods could also be shipped from a separate facility to fulfill the order. Such separate facilities include distribution centers or foreign importers.

After distributing the goods, the supplier 18 transfers a third set of funds to the selected local retailer 20. The third set of funds is a reward or e-bonus given to the selected local retailer 20 for offering to sell the supplier's 18 goods, but losing the sale to the supplier 18. The third set of funds is determined independently by the supplier 18 and each local retailer 20. The facilitator 16 does not control the amount of the third set of funds. The facilitator 16 only notifies or alerts the local retailer 20 of the customer's 14 purchase. As an alternative, shown in FIG. 4, the facilitator 16 could transfer the third set of funds to the local retailer 20. This alternative, however, would be at the request of the supplier 18. To accomplish this alternative, the second set of funds transferred to the supplier 18 would be reduced not only by the facilitator's 16 processing fee, but also by the amount of the third set of funds. The amount of the third set of funds would still be determined by the supplier 18 and each local retailer 20. The third set of funds permits the local retailers 20 to receive a benefit from the purchase even though the purchase occurred directly with the supplier 18. The third set of funds compensates the local retailer 20 for losing the customer 14 to the supplier 18 and eliminates the competition that would inherently develop between the local retailer 20 and the supplier 18 for the same customers 14.

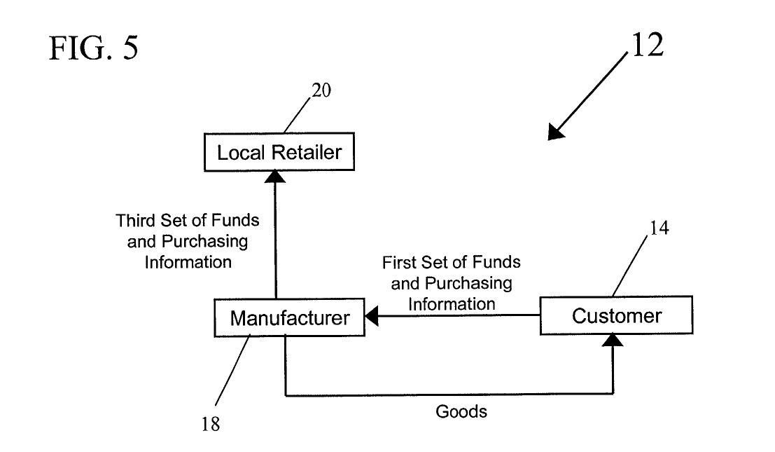

The alternative embodiment 12 of the subject invention, outlined in FIG. 5, does not use a facilitator 16. Instead the customer 14 views the internet website to purchase goods and is linked directly to the supplier 18. The supplier 18 performs all of the functions of the facilitator 16 in the first method. The local retailers 20 create an account, including transaction data, with the supplier 18. The supplier 18 receives the purchasing information and the first set of funds from the customer 14. The supplier 18 then forwards the third set of funds or reward to the selected local retailer 20 along with the purchasing information. This alternative embodiment eliminates the facilitator 16 and the fee withheld by the facilitator 16 from the first set of funds. This method either decreases the total cost of the products to the customer 14 or increases the profits of the supplier 18. Regardless, the supplier 18 performs all of the functions of the facilitator 16, including storing the purchasing information. The supplier 18 also continues to ship the purchased goods to the customer 14, either directly or via a distribution center or importer.

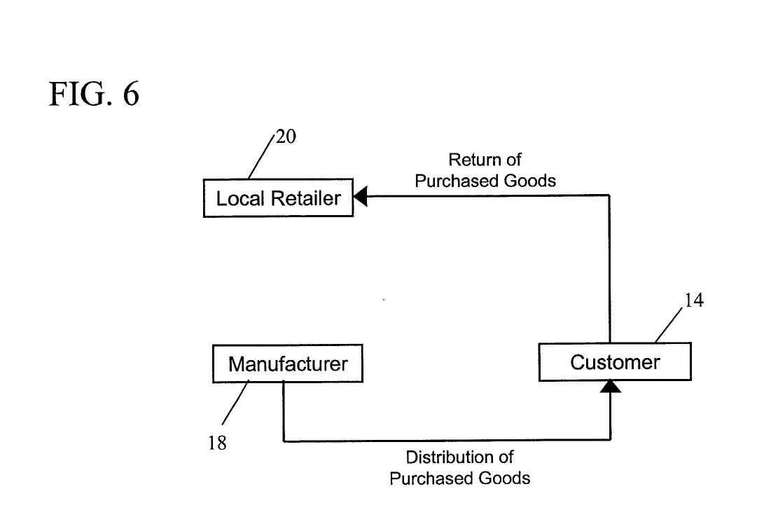

If, for some reason, the customer 14 was dissatisfied with his purchase of goods through the internet website, he would seek relief with the selected local retailer 20 as shown in FIG. 6. A condition of the local retailer 20 receiving the third set of funds or reward is to provide personal service to the supplier's 18 dissatisfied customers 14. A customer 14 would seek a refund and return the purchased goods at the selected local retailer 20. The ability of a customer 14 to deal directly with the local retailer 20 concerning problems with the purchased goods provides the customer 14 with greater satisfaction. Although purchasing goods is more convenient for the customer 14 through the internet website, when problems occur most customers 14 prefer the personal service of a local retailer 20.

Obviously, many modifications and variations of the present invention are possible in light of the above teachings. The invention may be practiced otherwise than as specifically described within the scope of the appended claims.

What is claimed is:

1. A method of purchasing and selling goods electronically, said method comprising the steps of:
viewing an internet website by a customer (14),
purchasing goods electronically from the internet website,
determining a local retailer (20) having jurisdiction over the purchase,
transmitting a first set of funds for payment of the goods,
transmitting a third set of funds to the local retailer (20) in response to the purchase.

2. A method as set forth in claim 1 wherein purchasing goods from the internet website includes transmitting the first set of funds for payment of the goods from the customer (14) to the supplier (18).

3. A method as set forth in claim 2 wherein purchasing goods from the internet website includes transmitting the third set of funds from the supplier (18) to the local retailer (20).

4. A method as set forth in claim 1 wherein purchasing goods from the internet website includes transmitting the first set of funds for payment of the goods from the customer (14) to a facilitator (16).

5. A method as set forth in claim 4 including transmitting a second set of funds from the facilitator (16) to the supplier (18).

6. A method as set forth in claim 4 wherein purchasing goods from the internet website includes transmitting the third set of funds from the facilitator (16) to the local retailer (20).

7. A method as set forth in claim 1 wherein purchasing goods from the internet website is further defined by linking the customer (14) to a supplier (18) to purchase the goods.

8. A method as set forth in claim 7 wherein linking to the supplier (18) includes creating an account between the supplier (18) and the local retailers (20).

9. A method as set forth in claim 4 wherein purchasing goods from the internet website is further defined by linking the customer (14) to the facilitator (16) to purchase the goods.

10. A method as set forth in claim 9 wherein linking to the facilitator (16) includes creating an account between the facilitator (16) and the supplier (18).

11. A method as set forth in claim 9 wherein linking to the facilitator (16) includes creating an account between the facilitator (16) and the local retailers (20).

12. A method as set forth in claim 1 wherein determining the local retailer (20) is further defined by matching the jurisdiction of local retailers (20) to the customer (14) supplied purchasing information and generating a list of local retailers (20) in response to said matching.

13. A method as set forth in claim 12 wherein determining the local retailer (20) further includes selecting the local retailer (20) by the customer (14) from the generated list of matching local retailers (20).

14. A method as set forth in claim 13 further including alerting the selected local retailer (20) of the purchase.

15. A method as set forth in claim 2 wherein purchasing goods from the internet website includes supplying purchasing information by the customer (14) to the supplier (18).

16. A method as set forth in claim 15 including storing customer (14) supplied purchasing information by the supplier (18) in a database.

17. A method as set forth in claim 4 wherein purchasing goods from the internet website includes supplying purchasing information by the customer (14) to the facilitator (16).

18. A method as set forth in claim 17 including storing customer (14) supplied purchasing information by the facilitator (16) in a database.

19. A method as set forth in claim 1 including distributing the purchased goods to the customer (14).

20. A method as set forth in claim 19 including returning the distributed purchased goods to the selected local retailer (20) by the customer (14) for reimbursement of the first set of funds.
